(19) United States
(12) Patent Application Publication
(10) Pub. No.: US 2018/0004544 A1
(43) Pub. Date: Jan. 4, 2018

(54) PERSONALIZED RUN TIME USER INTERFACES

(71) Applicant: SAP SE, Walldorf (DE)

(72) Inventors: Michail Vasiltschenko, Schriesheim (DE); Ralph Debusmann, Ludwigsburg (DE); Florian Hoffmann, Oftersheim (DE); Benjamin Schork, Wilhelmsfeld (DE); Guenther Fischer, Nussloch (DE); Yvonne Miklosch, Nussloch (DE); Jochen Geib, Speyer (DE)

(21) Appl. No.: 15/199,126

(22) Filed: Jun. 30, 2016

(51) Int. Cl. G06F 9/44; G06F 3/0484; G06F 17/30; H04L 29/08

(52) U.S. Cl. CPC G06F 9/4443; H04L 67/26; G06F 3/0484; G06F 17/30867

(57) ABSTRACT

A system includes a memory and a semiconductor-based processor coupled to form logic circuits. The logic circuits provide a combined localization and personalization (LPN) web service to a computer application, receive a call from the computer application for recommendations to localize and personalize an application user interface (UI) for a particular user, prepare a recommendation on which features and UI elements to include in a localized and personalized application UI (LPN UI) for the particular user, and return the recommendation to the computer application to set up the LPN UI.

### BACKGROUND

A computer application's user interface (“application UI”) is a visual part of the computer application through which a user interacts with the computer application. The application UI, which may be shown on a display screen of a computer, determines how commands are given to the computer or the computer application and how information is displayed on the display screen.

In a traditional scenario, the computer application (as coded) may define a “fixed” appearance or layout of the application UI including control buttons, menus, and other interface elements of the UI that are made available for the user to interact with the computer application. In some instances, the computer application may be coded so that the size and content of the application UI automatically vary with or adjust to the size of the display screen of the computer (e.g., mobile computer, desktop computer, etc.). In some instances, the application UI may include design tools which allow a user to personalize the application UI (e.g., by removing, adding or modifying Graphical user interface (GUI) elements in the application UI).

In some scenarios, different “localized” versions of the computer application may be coded to provide different versions of the application UI for different markets or groups of users (e.g., localized groups corresponding to different languages or cultures). For example, a version of the computer application may be coded to provide an English language UI for a first group of users while another version of the application may be coded to provide a German language UI for a second group of users. While coding different versions of the application UI may encourage acceptance of the computer application across the different markets or groups of users, it may be expensive to code and maintain the different localized versions of the computer application.

Consideration is now being given to systems and methods for combining localization and personalization of an application UI of a computer application without having to code and maintain different localized versions of the computer application.

### SUMMARY

A system for combined localization and personalization of an application user interface (UI) which a computer application presents to a particular user on a client computer device is described herein. The system includes a memory and a semiconductor-based processor that forming one or more logic circuits.

In a general aspect, the logic circuits are configured to provide a combined localization and personalization (LPN) web service to the computer application, receive a call from the computer application for recommendations to localize and personalize the application UI for the particular user, prepare a recommendation on which features and UI elements to include in a localized and personalized application UI (LPN UI) for the particular user, and return the recommendation to the computer application to setup the LPN UI.

The details of one or more implementations are set forth in the accompanying drawings and the description below. Further features of the disclosed subject matter, its nature and various advantages will be more apparent from the accompanying drawings, the following detailed description, and the claims.

### BRIEF DESCRIPTION OF THE DRAWINGS

FIG. 1 is a schematic block diagram of an example system for combined localization and personalization of an application UI, in accordance with the principles of the present disclosure.

FIG. 2 is a schematic block diagram illustrating a microservices architecture (MSA) of a localization and personalization (LPN) service, which may be provided a LPN service broker to a computer application at application run time, in accordance with the principles of the present disclosure.

FIG. 3 is an illustration of an example method for combined localization and personalization of an application user interface (UI) which a computer application presents to a particular user on a client computer device, in accordance with the principles of the present disclosure.

### DETAILED DESCRIPTION

Computer-implemented systems and methods for localization and personalization of an application UI of a computer application are described herein.

The systems and methods may be used to provide combined localization and personalization of the application UI for a particular user of the computer application. The combined localization and personalization of the application UI may be provided by a backend computer system as a remote service to the computer application to localize and personalize the application UI on a client computer device through which the particular user interacts with or accesses the computer application.

The combined localization and personalization of the application UI may involve changing or altering features and control elements that are included within the application UI. The changes and alterations may be based on information on characteristics of the particular user, the client computer device used, and the particular user's past or present usage of the client computer device. This information (which may be referred to herein as “user information”, “user profile” or “user metadata”) may include information on personal and cultural characteristics (e.g., the user's nationality, language, geographic location, computer usage habits, mouse movement/click behavior, etc.), information on technical characteristics (type of computing device, O/S used, network connection speed, etc.) and information on any other characteristics (e.g., behavioral characteristic related to computer usage, etc.) that may, for example, affect user's experience with the application UI. The information on which the combined localization and personalization of the application UI is based may be dynamically collected in, and retrieved from, one or more databases or data stores.

The combined localization and personalization of the application UI for the particular user may involve applying a predetermined set of “localization and personalization” rules (“LPN rules”) to the user information to generate recommended features and UI elements that should be assigned to, or included in, the application UI so that the application UI is localized and personalized to the particular user. The LPN rules may be designed to enhance or improve user experience with the application UI by including features and UI elements that are suited to the particular user's devices, tasks, preferences, and abilities.

The systems and methods described herein may involve using an algorithm which, at run-time, applies the LPN rules to user information collected from various input channels to localize and personalize the application UI for the particular user. In example implementations, the user information to which the LPN rules are applied may include the user's IP address, additional user information provided by the user at time of sign in, user behavior (e.g., as analyzed using Machine Learning), explicit user feedback, etc.

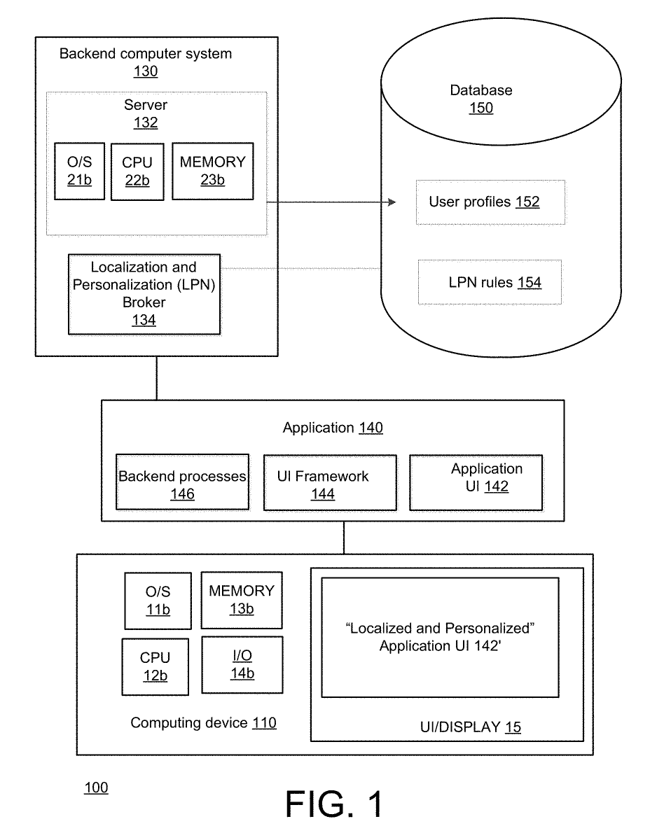

FIG. 1 is a schematic block diagram showing an example system 100 for combined localization and personalization of an application UI (e.g., application UI 142) of a computer application (e.g., computer application 140), in accordance with the principles of the present disclosure.

System 100 may include a backend computer system 130 connected to a client computing device 110 and a database 150. Database 150 may include user information 152 and LPN rules 154.

Client computing device 110 may, for example, include an O/S 11b, a CPU 12b, a memory 13b, and I/O 14b, may further include a user interface (UI) or display 15. Backend computer system 130 may include one or more computing devices (e.g., sever 132) which like client computing device 110 may include computer components such as an O/S 21b, a CPU 22b and a memory 23c, etc. Although server 132 is illustrated in the example of FIG. 1 as a single computing device, it may be understood that server 132 may represent two or more computing devices in communication with one another. Therefore, it will also be appreciated that any two or more components of system 100 may similarly be executed using some or all of the two or more computing devices in communication with one another. Conversely, it also may be appreciated that various components illustrated as being external to server 132 may actually be implemented therewith.

In system 100, computer application 140 may be hosted on one or more computers (including, for example, server 132, client computing device 110 or other virtual or physical machines). Computer application 140 may include application processes (e.g., server or backend processes 146), a UI framework 144, and a front end (e.g., application UI 142). Application UI 142 may be presented on client computing device 110 for a user to interact with or access computer application 140.

Backend computer system 130, which may be coupled to a database 150, may include processes that are configured to provide a “localization and personalization” (LPN) service to adapt or modify application UI 142 at run time and present it as a localized and personalized UI (e.g., localized and personalized application UI (LPN UI) 142′) that a particular user can use to interact with or access computer application 140 on client computing device 110. The LPN service may be provided as a web service, for example, by a “localization and personalization” (LPN) service broker 134 in backend computer system 130. The adaptation or modification of application UI 142 at run time as LPN UI 142′ for a particular user may be based, for example, on user specific data (e.g., user profiles 152) retrieved from database 150 or other data stores. The adaptation or modification of application UI 142 as a LPN UI 142′ for the particular user may involve implementing pre-determined localization and personalization rules (e.g., LPN rules 154) for various use contexts.

In an example implementation, LPN service broker 134 may have a microservices architecture (MSA) and may be configured to provide the LPN web service as a collection of one or more microservices (e.g., Base Microservice, Geographic Microservice, OS Microservice, Disability Microservice, etc.). In the example implementation, the collection of one or more microservices may include at least the Base Microservice while the other microservices (e.g., Geographic Microservice, OS Microservice, Disability Microservice, etc.) may be optional. The microservices may have access to user information (e.g., user profiles 152/database 150) and may accordingly generate respective recommendations for adapting or modifying application UI 142 as LPN UI 142′ for the particular user. In an example implementation, the recommendations may be delivered by LPN service broker 134 to computer application 140 using push technology (e.g., server push) communications.

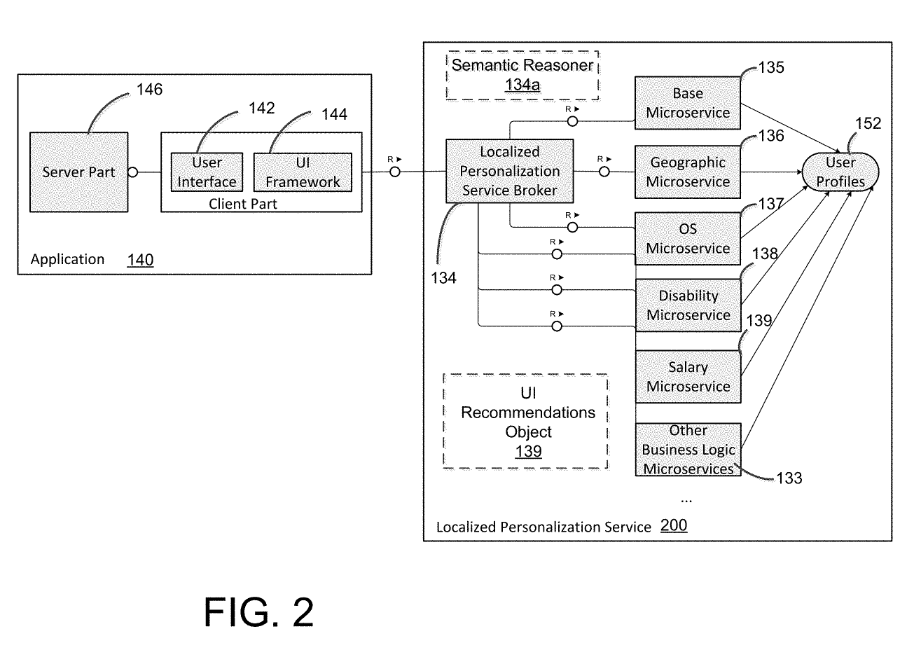

FIG. 2 is a schematic block diagram illustrating the microservices architecture (MSA) of an example LPN web service 200, which may be provided by LPN service broker 134 to computer application 140 at application run time. LPN web service 200 may, for example, include one or more microservices (e.g., Base Microservice 135, Geographic Microservice 136, OS Microservice 137, Disability Microservice 138, Salary Microservice 139, Other Microservices 133, etc.) for recommending UI changes to computer application 140 for a particular user. Each of the microservices may generate respective recommended UI changes by processing data (e.g., user profiles 152) related to the particular user and implementing pre-determined localization and personalization rules (e.g., LPN rules 154).

In an example implementation, Geographic Microservice 136 may be configured to provide recommendations for naming geographical features (e.g., a map of the Falkland Islands) in application UI 142. The recommendations may be based applying a LPN rule based on the particular user's likely sensitivities or preferences (as determined from user profile 152) for geographical names. For example, if the particular user has Argentinian citizenship, Geographic Microservice 136 may recommend that the map should labelled “Malvinas” in accordance with the preferred Argentinian name for the islands instead of “Falkland Islands”.

Further, in the example implementation, OS Microservice 137 may be configured to provide recommendations for layout or patterns of UI elements in UI 142 by applying a LPN rule to information on the O/S of the client computing device (e.g., client computing device 110) on which UI 142 will be presented. The recommendations for layout or patterns of UI elements in UI 142 according to the LPN rule may, for example, stipulate an order of buttons displayed in the UI based on the particular O/S of the client computing device (as determined, for example, from user profile 152). For a Windows-based client computing device, the recommendations for OK/Cancel dialogs may, for example, include placing the OK button on the left side and the Cancel button on the right side of the UI. Conversely, for a MacOS-based computing device, the recommendations for the OK/Cancel dialogs may, for example, include placing the OK button on the right side and the Cancel button on the left side of the UI.

Further, in the example implementation, Disability Microservice 138 may be configured to provide recommendations to modify UI 142 to ameliorate the effect of disabilities (e.g., physical disabilities) that the particular user may have in interacting with UI 142. For example, if the particular user has red-green color blindness (as determined from user profile 152) Disability Microservice 138 may, applying a LPN rule, recommend a color scheme that does not rely on a red-green contrast for visually contrasting UI elements in UI 142.

With renewed reference to FIG. 2, in operation, at application run time, computer application 140 may call LPN service broker 134 to get recommendations for UI 142 setup. In example implementations, either UI 142 itself or UI framework 144 of application 140 may call LPN service broker 134 to get the recommendations for UI 142 setup. The call may be for a specific micro service or recommendation type (e.g., Geographic recommendation) or for a compound object of different micro services or recommendation types.

In response to the call, LPN service broker 134 may activate or call one or more of the individual microservices (e.g., Base Microservice 135, Geographic Microservice 136, OS Microservice 137, Disability Microservice 138, etc.) to get the recommendations for localizing and personalizing UI 142.

In an example implementation, a called microservice (e.g., OS Microservice 137) may retrieve user-related information from the user profile database 152, which information may be shared by LPN service broker 134 with other microservice (e.g., Base Microservice 135, Geographic Microservice 136, Disability Microservice 138, etc.). Such sharing of retrieved user-related information may reduce the number of queries made by individual microservices to retrieve user-related information from user profile database 152.

Further, in some instances, the user-related information retrieved from user database 152 (e.g., retrieved by Geographic Microservice 136) may be analyzed (e.g., by logical reasoning) to infer additional facts about a user that may be useful for localizing and personalizing UI 142. These additional facts may or may not be explicitly stored in user database 152. In an example implementation, LPN service broker 134 may include, or be coupled to, a “logical or semantic reasoner” (e.g., semantic reasoner 134a, FIG. 2). Semantic reasoner 134a may be configured to process the user-related information retrieved from user database 152 to infer the additional facts that are not explicitly included in the retrieved user-related information or stored in database 152.

Semantic reasoner 134a (which, for example, may be based on “semantic web technologies”) may be configured to access one or more knowledge bases, which may represent facts, for example, about computer usage, cultures, and human behavior, etc. Semantic reasoner 134a may reason about those facts and use rules and other forms of logic to infer additional facts that may be relevant, for example, to the user's present circumstances or context (e.g. location, device use, connectivity, history, etc.).

Semantic reasoner 134a may be configured to process the user-related information retrieved from user database 152 to determine the user's present circumstances and to discover or infer additional facts (e.g., from the knowledge bases) that may be relevant to customizing and personalizing UI 142 based on the user's specific circumstances (e.g. location, device use, connectivity, history, etc.) at the time of the call to LPN service broker 134 to get the recommendations for UI 142 setup.

As an example of the operation of semantic reasoner 134a, the user-related information retrieved from user database 152 may include the fact that the user is working, for example, from South Africa. Semantic reasoner 134a may discover, for example, from a knowledge base, the fact that South Africa has poor quality Internet connections. Semantic reasoner 134a may logically infer from these facts (i.e. that the user is working from South Africa and that South Africa has poor quality internet connections) the additional fact: the user has a poor quality internet connection that is prone to frequent interruptions or breaks.

LPN service broker 134/semantic reasoner 134a may then, for example, apply a LPN rule (from LPN rules 154) for internet connection quality to this logically inferred additional fact (which may or may not be stored in database 152) to recommend a feature of a high auto-save frequency for localizing and personalizing UI 142 for the user.

In an example implementation, LPN service broker 134 may always first call Base Microservice 135 to retrieve user-related information from the user profile database 152. LPN service broker 134 may then call one or more of the other individual microservices (e.g., Geographic Microservice 136, OS Microservice 137, Disability Microservice 138, etc.) to get the their recommendations for localizing and personalizing UI 142. The user-related information retrieved by the first called Base Microservice may be made available for processing to the other microservices that may have been called to get their respective recommendations. Alternatively or additionally, the LPN service broker 134/semantic reasoner 134a may process the user-related information to logically infer additional facts useful for recommending features for localizing and personalizing UI 142.

In an example implementation, LPN service broker 134 may first receive the base recommendations from the Base Microservice, and then the additional recommendations from the one or more of the other individual microservices (e.g., Geographic Microservice 136, OS Microservice 137, Disability Microservice 138, etc.). LPN service broker 134 may combine and store the respective recommendations received from the individual microservices in a shared object (e.g., UI recommendations object 139), which is then returned to computer application 140. Computer application 140 may, based on the recommendations in UI recommendations object 139 adapt or modify UI 42 for presentation as LPN UI 142′ on client computing device 110.

In the example implementation, LPN service broker 134 may include a “recommendations object” function which for a given user and given user metadata (e.g. the user's IP address, the Browser metadata, etc.) returns a recommendations object (e.g., UI recommendations object 139). The returned recommendations object may include the recommendations for UI 142 provided by one or more of the microservices included in LPN web service 200.

The following pseudo-code snippet (in Java) illustrates an example implementation of the function, which returns UI recommendations object 139: Recommendations object function pseudo-code

public static Recommendations getRecommendations(User user,
UserMetaData userMetaData) {

// Open user profile database and get the user profile for the user.
UserProfileDb userProfileDb = new

DbConnection(“userProfileDb”).open( );

UserProfile userProfile = dbConnection.getUserProfile(user);
// Get base recommendations.
BaseRecommendations baseRecommendations =

BaseMicroservice.getBaseRecommendations(userProfile, userMetaData);

// Get other recommendations.
GeographicRecommendations geographicRecommendations =

GeographicMicroservice.getGeographicRecommendations(userProfile,
userMetaData, baseRecommendations);

OSRecommendations osRecommendations =

OSMicroservice.getOSRecommendations(userProfile, userMetaData,
baseRecommendations);

DisabilityRecommendations disabilityRecommendations =

Disability Microservice.getDisabilityRecommendations(userProfile,
userMetaData, baseRecommendations);

//...
// Store all recommendations in a Recommendations object.
Recommendations recommendations = new Recommendations( );
recommendations.setGeographicRecommendations(geographicRecommen

dations);

recommendations.setOSRecommendations(osRecommendations);
recommendations.setDisabilityGeographicRecommendations(disabilityRe

commendations);

//...
// Close the user profile database.
userProfileDb.close( );
// Return the recommendations.
return recommendations;

}

Other functions, methods and microservices of LPN service broker 134 may be implemented using similar code. The following pseudo-code snippet (in Java) illustrates an example implementation of Geographic Microservice 136:

### Geographic Microservice Pseudo-Code

public static GeographicRecommendations
getGeographicRecommendations(UserProfile userProfile, UserMetaData
userMetaData, BaseRecommendations baseRecommendations) {

// Create a GeographicRecommendations object.
GeographicRecommendations geographicRecommendations = new

GeographicRecommendations( );

// If the user location is around Stanley (capital of the Falkland
Islands),
// the user language is English and the citizenship is Argentinian,
return

“Malvinas”.

// If the citizenship is British, return “Falkland Islands”.
if (userMetaData.getLocation( ).around(“51°42′S 57°51′W”)) {

if (userProfile.getLanguage( ).equals(“English”)) {

if (userProfile.getCitizenship( ).equals(“Argentinian”)) {

geographicRecommendations.setLabel(“Malvinas”);

} else if (userProfile.getCitizenship( ).equals(“British”)) {

geographicRecommendations.setLabel(“Falkland

Islands”);

}

} ...

} ...
// Return the GeographicRecommendations object.
return geographicRecommendations;

}

According to the foregoing Geographic Microservice pseudo-code, if the user metadata indicates that the user is located on the Falkland Islands or wants to view a map with the Falkland Islands on it, and, in addition, the user profile includes information that the user's language is English, then if the user has Argentinian citizenship, the geographic label recommendation becomes “Malvinas.” If the user has British citizenship, the geographic label recommendation becomes “Falkland Islands.”

In example implementations of system 100, LPN rules 154 that are used to select or assign UI elements to localize and personalize the application UI may include a category of rules that are related to broad characteristics of an individual user (e.g., location, region or country, and cultural background, etc.), a category of rules that are related to more specific characteristics of the individual user (e.g., devices, tasks, preferences, and abilities, etc.) and another category of rules that are related to characteristics of the computing device used to access the computer application. Examples of the different categories of LPN rules are described below.

### Example LPN Rules Related to Localization/Region/Cultural Background

Rules for Geographic Names/Political Issues: Users may have sensitivities and preferences for geographic names on maps. For example, for a user from Argentina, it may be politically insensitive to label “Falkland Islands” on the application UI for the islands that the Argentinians call “Malvinas.” To mitigate such sensitivities, according to an example LPN rule, when a user calls up computer application 140 from Argentina, the label “Malvinas” may be assigned to the application UI instead of the label “Falkland Islands.”

Rules for Colors: Colors often have different cultural connotations in different regions of the world. For example, in Western countries, green color may be associated with wins (plus) and red color may be associated losses (minus) (e.g., in stock market win/loss displays). However, in China, the colors may have the opposite meaning with red color associated with wins and green color associated with losses. Similarly, in Western countries, black color may be associated with sorrow, whereas in China, white color may be associated with sorrow. To account for the different cultural connotations of colors, example LPN rules for colors may assign suitable colors for the application UI depending on the location/origin of the user.

Rules for Religion and other sensitivities: To account for the different religious sensitivities, example LPN rules for religion may adapt the UI texts and imagery in the application UI based on information on the religious sensitivities of the user in order to avoid any offense. Similarly, example LPN rules may customize advertising in the application UI to the social, political and cultural interests or affiliations of the user. For example, is there is information that the user is a follower of so-called “Jedism” (i.e. is interested in Star Wars movies), an example LPN rule may exclude advertising or imagery for the competing Star Trek movies from the application UI.

Rules for Language Variants: Users may prefer to see the application UI in their native language variant or dialect. For example, many users from the US may perceive the application UI to be better if it is presented to them in American English, whereas users from Britain may perceive the application UI to be better if it is presented in British English. Example LPN rules for language variants may assign a suitable language variant for the application UI depending on the location/origin of the user.

Rules for Predominant Languages: Different regions of a country may have different predominant languages. For example, users from the Catalonia region in Spain may perceive the application UI to be better if it is presented in in Catalan, whereas users from other parts of Spain may prefer Spanish. Example LPN rules for predominant languages may assign a predominant language for application UI depending on the region in which the user located.

Rules for Cultural Sensitivity: In some cultures (e.g., Japan) users may consider direct messages (e.g., “You made a mistake”) to be more offensive than in other cultures. To avoid offending the user, an example LPN rule for cultural sensitivities may assign the types of message which can be displayed in the application UI based on the cultural background of the user. Further, for example, users in some cultures may be particular about names and courtesy titles (e.g., Sir, Herr Prof, Mrs. Miss, Ms., etc.) when addressing a person. To accommodate the user's cultural preference for names and courtesy titles, an example LPN rule for cultural sensitivities may assign different types of address fields in the application UI based on the cultural background of the user.

Rules for related to Icons, Emoticons, Fonts, etc.: Different countries or regions of the world may have different preferences for icons, emoticons, fonts or other artifacts in the application UI. For example, Chinese users may prefer more “beautiful and stylish” fonts, whereas Western users may prefer simpler and more pragmatic fonts. Example LPN rules may address these preferences by selecting the preferred styles of the artifacts (e.g. icons, emoticons, fonts, etc.) for use in the application UI based on the location of the user.

### Example LPN Rules Related to Specific Characteristics of a User

Rules Related to Gender: A study shows men and women have different perceptions of, and interactions with, an application UI. According to the study, male subjects emphasized control over the computer, and preferred many movements on the screen. In contrast, female subjects preferred a “calmer” user interface with fewer movements on the screen. An example LPN rule related to gender may select suitable UI elements for the application UI according to the gender of the user.

Rules related to Computer Usage: Some users may be inclined to use a keyboard instead of a pointing device (e.g., a mouse) to interact with the application UI. Conversely, in other instances some users may be inclined to use the mouse instead of a touchscreen to interact with the application UI. An example LPN rule may adapt the application UI to the user's habits (e.g., by explicitly offering keyboard shortcuts for keyboard aficionados).

In an example implementation, system 100 may detect the attention span of a user when focusing on the display screen. Some users may have a limited attention span of only a few seconds focusing on the display screen. An example LPN rule may adapt the application UI to present small pieces of the application UI in a fast mode to users with limited attention span, while presenting large pieces of the application UI in a slow mode to other users who do not have a limited attention span.

In another example implementation, system 100 may determine how experienced a user is in using the computer application or how frequently the user uses the computer application. An example LPN rule may adapt the application UI to match the user's experience level (e.g., by including more “help” UI elements in the application UI for users with a low level of experience). Another example LPN rule may adapt the application UI to include more “help” UI elements for an infrequent user. Further, yet another example LPN rule may modify the application UI for a frequent user by hiding widgets that are not used often and/or by adding shortcuts (e.g., keyboard shortcuts, button widgets, etc.) for the most commonly used functionalities or tasks of the application UI.

Rules related to visitors to a region: System 100 may determine that a user is a visitor (e.g., an immigrant. a tourist, or a business traveler) in a region from which the user is attempting to access the computer application. System 100 may, for example, determine that a user is not a native but a visitor if the user's computer has settings (e.g., language, keyboard, etc.) that are not typical of other users in the region. An example LPN rule may localize the application UI for the user's native country or region (as may be indicated by the user's computer settings).

Rules related to disabilities and physical impairments: Example LPN rules may adapt or modify the application UI to help users with disabilities or physical impairments in using the application UI. An example LPN rule may modify the application UI to display UI components in a high-contrast mode for a user with general sight impairments. Another example LPN rule may modify the application UI to highlight UI components to render the components more clearly visible to a user with red-green color blindness. The example LPN rule may, for example, modify the application UI by replacing red colored text with blue colored text (or by underlining the text) to render the text more clearly visible to the user with red-green color blindness.

Rules Related to Education Levels: Example LPN rules may adapt the application UI based on the education level of the user. An example LPN rule may modify the application UI to include simplified language if, for example, it is determined that the user has an education level corresponding to vocabulary of less than 2000 words or below that of a certain grade level.

Rules Related to Age: Example LPN rules may adapt the application UI based on the age of the user. An example LPN rule may, for example, use a larger typeface in the application UI for older users. Another example LPN rule may, for example, include different idioms, icons, and textual buttons in the application UI for older users than for younger users.

Rules Related to Personality: Studies show that user with extroverted and introverted personalities have different interaction styles and preferences for an application UI. An example LPN rule may adapt the application UI by using different wordings of texts, layout and structure for the application UI according to whether the user has an extroverted or introverted personality.

### Example LPN Rules Related to Characteristics of the Computing Device

Rules related to Network Bandwidth: System 100 may be configured to detect conditions (e.g., bandwidth and latency) of the network connection used to access the computer application. An example LPN rule may adapt or modify the application UI to account for poor network conditions. The example LPN rule may, for example, exclude large images or video from the application UI when the network bandwidth is small. Other example LPN rules may place the application in an off-line mode or increase a frequency of an auto-save function when the system detects instability in the network connection.

Rules related to Network Latency: An example LPN rule may limit the number of network accesses if system 100 detects high latency in the network connection.

Rules related to computing device Operating System: Different computing devices may have different operating systems that differ in subtle aspects that the user may be accustomed to. For example, in typical Yes/No or OK/Cancel dialogs, Windows O/S users may be accustomed to the positive button (OK) being displayed on the left side of the UI, and the negative button (Cancel) being displayed on the right side of the UI. Conversely, MacOS users may be used to the mirror image (i.e. Cancel button on the left side, OK button on the right side). An example LPN rule related to computing device O/S may select UI elements and layout for the application UI based on the O/S deployed in the user's computing device. Information on which O/S is deployed in a computing device may be determined by system 100 from web browser metadata. An example LPN rule related to computing device O/S may select the UI elements and the layout for the application UI based on the O/S deployed in the user's computing device.

Rules related to Display Resolution or Size: Different computing devices (e.g., desktop, laptop, smartphone, and tablet, etc.) may have respective displays having different resolutions or sizes. Example LPN rules related to display resolution or size may adapt the application UI to the user's device (laptop, smartphone, tablet) by resizing, rearranging excluding or including UI elements in the application UI.

It will be understood that while several example LPN rules have been described in the foregoing only for purposes of illustration, different implementations of system 100 may deploy only some or all of the foregoing LPN rules, and/or deploy additional LPN rules other than the example LPN rules described herein.

Further, it will be understood that system 100 may utilize machine learning techniques to update or refine LPN rules 154 and other aspects of the system (e.g., semantic reasoner logic, LPN service broker, micro services, databases, etc.) to continually improve system performance and efficiency. Additional facts inferred by semantic reasoner may be incorporated in local databases and LPN rules 154 so that repeated operation of the semantic reasoner to infer the same additional facts can be avoided. For example, based on the example semantic reasoner operation (regarding a user working from South Africa) discussed in the foregoing, machine learning may create a new LPN rule that automatically attributes low internet connection quality to all users in South Africa and recommends a feature of a high auto-save frequency for localizing and personalizing UI 142 for all users in South Africa, without a need to operate the semantic reasoner again to discover the fact that South Africa has poor quality internet connections or to infer the additional fact the users in South Africa have poor quality Internet connections that are prone to frequent interruptions or breaks.

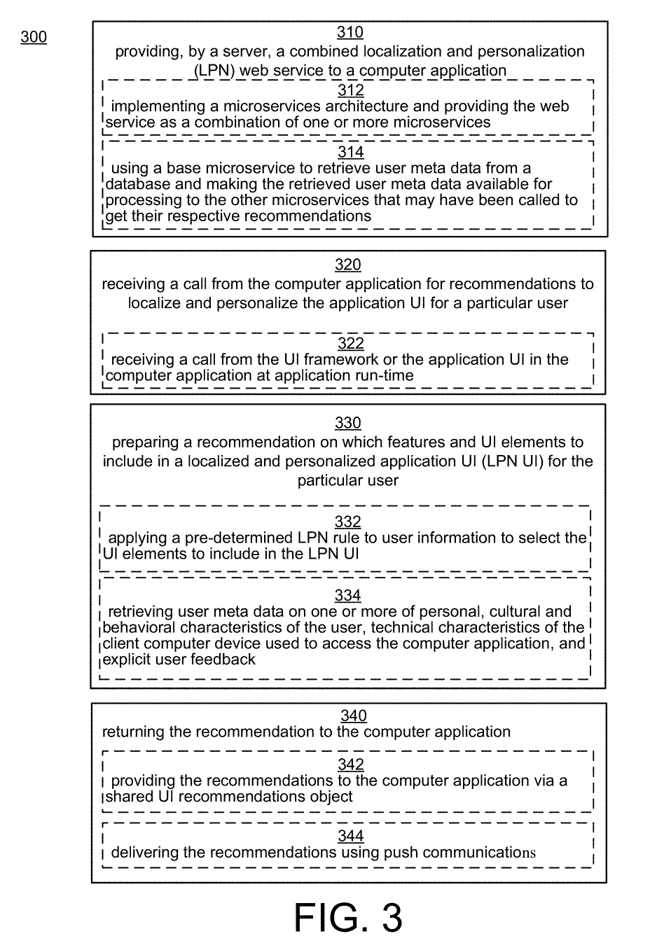

FIG. 3 shows a method for combined localization and personalization of an application user interface (UI) which a computer application presents to a particular user on a client computer device, in accordance with the principles of the present disclosure.

The computer application, which may be hosted on one or more physical or virtual machines (e.g., in a cloud computing network), may include a UI framework and the application UI. The application UI may represent a front end of the computer application on the client computer device, through which a user may interact with, or access, the computer application.

Method 300 includes providing, by a server, a combined localization and personalization (LPN) web service to the computer application (310), receiving a call from the computer application for recommendations to localize and personalize the application UI for a particular user (320), preparing a recommendation on which features and UI elements to include in a localized and personalized application UI (LPN UI) for the particular user (330); and providing the recommendation to the computer application (340).

In method 300, providing, by a server, a combined localization and personalization (LPN) web service to the computer application 310 may include implementing a microservices architecture (MSA) and providing the web service as a combination of one or more microservices (312). Each of the microservices may be configured to provide a respective recommendation on which features and UI elements to include in the LPN UI.

Providing the web service as a combination of one or more microservices 312 may include using a base microservice to retrieve user metadata from a database and making the retrieved user metadata available for processing to the other microservices that may have been called to get their respective recommendations (314). Method 300 may further include combining the respective recommendations received from the individual microservices in a shared object.

Receiving a call from the computer application for recommendations to localize and personalize the application UI for a particular user 320 may include receiving the call (e.g., at application run-time) from the UI framework or the application UI in the computer application (322).

Further, preparing a recommendation of which features and UI elements to include in a localized and personalized application UI (LPN UI) for the particular user 330 may include applying a pre-determined LPN rule to user information to select the features and UI elements to include in the LPN UI (332).

Applying a pre-determined LPN rule to user information 332 may include retrieving user metadata on one or more of personal, cultural and behavioral characteristics of the user, technical characteristics of the client computer device used to access the computer application, and explicit user feedback (334).

In method 300, providing the recommendation to the computer application 340 may include providing the recommendations to the computer application via a shared UI recommendations object (342). Further, providing the recommendation to the computer application 340 may include delivering the recommendations using push communications (344).

The various systems and techniques described herein may be implemented in digital electronic circuitry, or in computer hardware, firmware, or in combinations of them. The various techniques may implemented as a computer program product, i.e., a computer program tangibly embodied in a machine readable storage device, for execution by, or to control the operation of, data processing apparatus, e.g., a programmable processor, a computer, or multiple computers.

Method steps may be performed by one or more programmable processors executing a computer program. Method steps also may be performed by, and an apparatus may be implemented as, logic circuitry or special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magnetooptical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a backend component, e.g., as a data server, or that includes a middleware component, e.g., an application server, or that includes a frontend component, e.g., a client computer having a graphical user interface or a Web browser through which a user can interact with an implementation, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method for combined localization and personalization of an application user interface (UI) which a computer application presents to a particular user on a client computer device, the method comprising:
providing, by a server, a combined localization and personalization (LPN) web service to the computer application;
receiving a call from the computer application for recommendations to localize and personalize the application UI for the particular user;
preparing a recommendation on which features and UI elements to include in a localized and personalized application UI (LPN UI) for the particular user; and
returning the recommendation to the computer application to set up the LPN UI.

2. The method of claim 1, wherein returning the recommendation to the computer application includes providing the recommendation to the computer application via a shared UI recommendations object.

3. The method of claim 1, wherein returning the recommendation to the computer application includes delivering the recommendation using push communications.

4. The method of claim 1, wherein receiving a call from the computer application includes receiving the call from a UI framework or the application UI in the computer application.

5. The method of claim 1, wherein receiving a call from the computer application includes receiving the call at application run-time.

6. The method of claim 1, wherein preparing a recommendation on which features and UI elements to include in a LPN UI for the particular user includes applying a pre-determined LPN rule to user information to select the features and UI elements to recommend for inclusion in the LPN UI.

7. The method of claim 1, wherein applying a pre-determined LPN rule to user information includes retrieving user metadata on one or more of personal, cultural and behavioral characteristics of the user, technical characteristics of the client computer device used to access the computer application, and explicit user feedback.

8. The method of claim 1, wherein providing a combined localization and personalization (LPN) web service to the computer application includes implementing a microservices architecture and providing the LPN web service as a combination of one or more microservices, each of the microservices configured to provide a respective recommendation on which features and UI elements to include in the LPN UI.

9. The method of claim 8, wherein providing the LPN web service as a combination of one or more microservices includes using a base microservice to retrieve user metadata from a database and making the retrieved user metadata available for processing to the other microservices.

10. The method of claim 8 further comprising combining the respective recommendations received from individual microservices in a shared object.

11. A system for combined localization and personalization of an application user interface (UI) which a computer application presents to a particular user on a client computer device, the system comprising a memory and a semiconductor-based processor, the memory and the processor forming one or more logic circuits configured to:
provide a combined localization and personalization (LPN) web service to the computer application;
receive a call from the computer application for recommendations to localize and personalize the application UI for the particular user;
prepare a recommendation on which features and UI elements to include in a localized and personalized application UI (LPN UI) for the particular user; and
return the recommendation to the computer application to setup the LPN UI.

12. The system of claim 11, wherein the logic circuits are configured to return the recommendation to the computer application via a shared UI recommendations object.

13. The system of claim 11, wherein the logic circuits are configured to return the recommendations using push communications.

14. The system of claim 11, wherein the logic circuits are configured to receive the call from the computer application from a UI framework or the application UI in the computer application.

15. The system of claim 11, wherein the logic circuits are configured to receive the call from the computer application at application run-time.

16. The system of claim 11, wherein the logic circuits are configured to prepare the recommendation on which features and UI elements to include in the LPN UI by applying a pre-determined LPN rule to user information to select features and UI elements to recommend for inclusion in the LPN UI.

17. The system of claim 16, wherein the logic circuits are configured to apply the pre-determined LPN rule to user information by retrieving user metadata on one or more of personal, cultural and behavioral characteristics of the user, technical characteristics of the client computer device used to access the computer application, and explicit user feedback.

18. The system of claim 11, wherein the logic circuits are configured to implement a microservices architecture and provide the LPN web service as a combination of one or more microservices, each of the microservices being configured to provide a respective recommendation on which features and UI elements to include in the LPN UI.

19. The system of claim 18, wherein the logic circuits are configured to use a base microservice to retrieve user metadata from a database and make the retrieved user metadata available for processing to the other microservices.

20. The system of claim 18, wherein the logic circuits are configured to combine the respective recommendations received from the microservices in a shared object.
